(19) United States
(12) Patent Application Publication
(10) Pub. No.: US 2023/0324763 A1
(43) Pub. Date: Oct. 12, 2023

(54) OPTICAL PHASED ARRAY ELECTRONIC BEAMFORMING CONTROL

(71) Applicant: Analog Photonics LLC, Boston, MA (US)

(72) Inventors: Benjamin Roy Moss, Cambridge, MA (US); Peter Nicholas Russo, Arlington, MA (US); Oleg Shatrovoy, Cambridge, MA (US); Christopher Vincent Poulton, Somerville, MA (US)

(73) Assignee: Analog Photonics LLC, Boston, MA (US)

(21) Appl. No.: 18/295,932

(22) Filed: Apr. 5, 2023

Related U.S. Application Data
(60) Provisional application No. 63/328,307, filed on Apr. 7, 2022.

(51) Int. Cl. G02F 1/29

(52) U.S. Cl. CPC G02F 1/292

(57) ABSTRACT

Operating an OPA includes: applying, by each phase shifter element an optical phase shift to an optical wave that propagates through the phase shifter element and propagates to a corresponding emitter element, where the optical phase shift is based on an electrical signal provided to the phase shifter element; providing, by each driver element an electrical signal to at least one of the phase shifter elements based on a digital code value received at an input of the driver element; and computing one or more digital code values that are provided to respective inputs of driver elements in the array of driver elements based on processing OPA control information. The processing includes: computing optical phase shift information based at least in part on the OPA control information, and computing a corresponding digital code value based at least in part on the optical phase shift information.

### CROSS-REFERENCE TO RELATED APPLICATION(S)

This application claims priority to and the benefit of U.S. Provisional Application No. 63/328,307, entitled “OPTICAL PHASED ARRAY ELECTRONIC BEAMFORMING CONTROL,” filed Apr. 7, 2022, incorporated herein by reference.

### STATEMENT AS TO FEDERALLY SPONSORED RESEARCH

This invention was made with government support under the following contract: DARPA Contract No. HR0011-16-C-0108. The government has certain rights in the invention.

### TECHNICAL FIELD

This disclosure relates to optical phased array (OPA) electronic beamforming control.

### SUMMARY

In one aspect, in general, an apparatus comprises: an array of emitter elements; an array of phase shifter elements, each phase shifter element configured to apply an optical phase shift to an optical wave that propagates through the phase shifter element and propagates to a corresponding emitter element, where the optical phase shift is based on an electrical signal provided to the phase shifter element; an array of driver elements, each driver element configured to provide an electrical signal to at least one of the phase shifter elements based on a digital code value received at an input of the driver element; and digital control circuitry configured to compute one or more digital code values that are provided to respective inputs of driver elements in the array of driver elements based on processing optical phased array control information, the processing including: computing optical phase shift information based at least in part on the optical phased array control information, and computing a corresponding digital code value based at least in part on the optical phase shift information.

In another aspect, in general, a method for operating an optical phased array comprising an array of emitter elements comprises: applying, by each phase shifter element in an array of phase shifter elements, an optical phase shift to an optical wave that propagates through the phase shifter element and propagates to a corresponding emitter element, where the optical phase shift is based on an electrical signal provided to the phase shifter element; providing, by each driver element in an array of driver elements, an electrical signal to at least one of the phase shifter elements based on a digital code value received at an input of the driver element; and computing, by digital control circuitry, one or more digital code values that are provided to respective inputs of driver elements in the array of driver elements based on processing optical phased array control information, the processing including: computing optical phase shift information based at least in part on the optical phased array control information, and computing a corresponding digital code value based at least in part on the optical phase shift information.

Aspects can include one or more of the following features.

Optical phased array control information comprises steering information associated with steering at least one optical beam formed by optical interference among optical waves emitted from the emitter elements in the array of emitter elements.

The steering information is based on a tilt angle of a propagation axis that is perpendicular to a wavefront of the optical beam with respect to a reference axis that is defined relative to a plane over which the array of emitter elements are distributed.

The steering information is computed by the digital control circuitry based on the tilt angle, a wavelength of the optical waves, and a distance between adjacent emitter elements in the array of emitter elements.

Optical phase shift information associated with a particular emitter element is computed based at least in part on the steering information and a position of the particular emitter element in the array of emitter elements.

A digital code value computed based at least in part on the optical phase shift information associated with the particular emitter element is computed based at least in part on calibration information associated with the particular emitter element.

The digital control circuitry is clocked by a clock signal during a sequence of clocked time intervals that are interleaved with a sequence of digital silence time intervals in which no clock signal is being distributed to the digital control circuitry.

During each of the clocked time intervals the digital control circuitry is computing at least a portion of the optical phase shift information, and during each of the digital silence time intervals the optical beam is steered to a predetermined point or within a predetermined plane.

The optical phase shift information and the corresponding digital code value are computed in a plurality of pipelined computing stages that occur within respective clocked time intervals and that include a final computing stage in which the corresponding digital code value is provided to a driver element over a resolving time interval.

Optical phased array control information comprises calibration information associated with calibrating at least one individual emitter element in the array of emitter elements.

Digital code values for a plurality of emitter elements other than the individual emitter element being calibrated are computed based on a pseudo-random pattern.

In another aspect, in general, an apparatus comprises: an array of emitter elements; an array of phase shifter elements, each phase shifter element configured to apply an optical phase shift to an optical wave that propagates through the phase shifter element and propagates to a corresponding emitter element, where the optical phase shift is based on an electrical signal provided to the phase shifter element; an array of driver elements, each driver element configured to provide an electrical signal to at least one of the phase shifter elements based on a digital code value received at an input of the driver element; and digital control circuitry configured to compute one or more digital code values that are provided to respective inputs of driver elements in the array of driver elements, wherein the digital control circuitry is clocked by a clock signal during a sequence of clocked time intervals. The computing by the digital control circuitry includes: during a first of the clocked time intervals the digital control circuitry is computing at least a portion of a first digital code value provided to an input of a first driver element, during a second of the clocked time intervals, after the first of the clocked time intervals, the digital control circuitry is computing at least a portion of a second digital code value provided to the input of the first driver element, and during an intermediate time interval, between the first of the clocked time intervals and the second of the clocked time intervals, an optical beam formed by optical interference among optical waves emitted from the emitter elements in the array of emitter elements is steered to a predetermined point or within a predetermined plane.

In another aspect, in general, a method for operating an optical phased array comprising an array of emitter elements comprises: applying, by each phase shifter element in an array of phase shifter elements, an optical phase shift to an optical wave that propagates through the phase shifter element and propagates to a corresponding emitter element, where the optical phase shift is based on an electrical signal provided to the phase shifter element; providing, by each driver element in an array of driver elements, an electrical signal to at least one of the phase shifter elements based on a digital code value received at an input of the driver element; and computing, by digital control circuitry, one or more digital code values that are provided to respective inputs of driver elements in the array of driver elements, wherein the digital control circuitry is clocked by a clock signal during a sequence of clocked time intervals. The computing by the digital control circuitry includes: during a first of the clocked time intervals the digital control circuitry is computing at least a portion of a first digital code value provided to an input of a first driver element, during a second of the clocked time intervals, after the first of the clocked time intervals, the digital control circuitry is computing at least a portion of a second digital code value provided to the input of the first driver element, and during an intermediate time interval, between the first of the clocked time intervals and the second of the clocked time intervals, an optical beam formed by optical interference among optical waves emitted from the emitter elements in the array of emitter elements is steered to a predetermined point or within a predetermined plane.

Aspects can include one or more of the following features.

The optical beam is steered to a predetermined point or within a predetermined plane based at least in part on the first digital code value.

The one or more digital code values are computed based on processing optical phased array control information received by the digital control circuitry.

The optical phased array control information comprises steering information associated with steering at least one optical beam formed by optical interference among optical waves emitted from the emitter elements in the array of emitter elements.

The steering information is based on a tilt angle of a propagation axis that is perpendicular to a wavefront of the optical beam with respect to a reference axis that is defined relative to a plane over which the array of emitter elements are distributed.

The steering information is computed by the digital control circuitry based on the tilt angle, a wavelength of the optical waves, and a distance between adjacent emitter elements in the array of emitter elements.

Optical phase shift information associated with a particular emitter element is computed based at least in part on the steering information and a position of the particular emitter element in the array of emitter elements.

The intermediate time interval comprises a digital silence time interval in a sequence of digital silence time intervals interleaved with the clocked time intervals, where, in each digital silence time interval, no clock signal is being distributed to the digital control circuitry.

Aspects can have one or more of the following advantages.

The techniques described herein can be used to electronically steer and/or calibrate a beam that is formed from light emitted from an integrated optical phased array. Photonic integrated circuits (PICs) with optical phased arrays (OPAs), such as those used for LiDAR, feature an increasingly high emitter element count (e.g., from hundreds to tens of thousands of emitter elements, or more). Each optical phase shifter element coupled to a respective emitter element can be controlled using individual phase control to steer the emitted beam formed from interference among the optical waves emitted from the different emitter elements.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example OPA system.

FIG. 2 is a schematic diagram of an example OPA system.

FIG. 3 is a schematic diagram of an example OPA system.

FIG. 4 is a schematic diagram of an example Control Electronic IC.

FIG. 5 is a diagram of OPA emission.

FIG. 6 is a diagram of OPA emission.

FIG. 7 is a diagram of an OPA computational model.

FIG. 8 is a diagram of an OPA computational model.

FIG. 9 is a timing diagram of an example OPA system.

FIGS. 10 and 11 are diagrams of example OPA patterns associated with digital beamforming controllers in an example OPA system.

### DETAILED DESCRIPTION

An individual optical phase shifter element (or simply “phase shifter element”) can be controlled electronically by adjusting the voltage across the phase shifter element, by adjusting the current through the phase shifter element, and/or by adjusting the power to the phase shifter element. In some system implementations, one or more electronic integrated circuits (EICs) contain digital-to-analog converters (DACs) to provide individual optical phase shifter control. Digital electronic input codes can command a single DAC to provide an individual phase shifter element with a specific phase setting. In such a system, the EIC can be tightly co-designed to meet system constraints including low footprint area and/or low power consumption. The EIC may include integrated digital logic (e.g., a “digital beamforming controller”) to supply the appropriate digital electronic input codes for the DACs to steer and/or calibrate the optical phased array. The digital logic can be implemented in the circuitry of an application specific integrated circuit (ASIC), for example, or in any of a variety of different types of digital circuitry, including any number of processor cores, or other processing engines, that may be included in, or in communication with, the EIC.

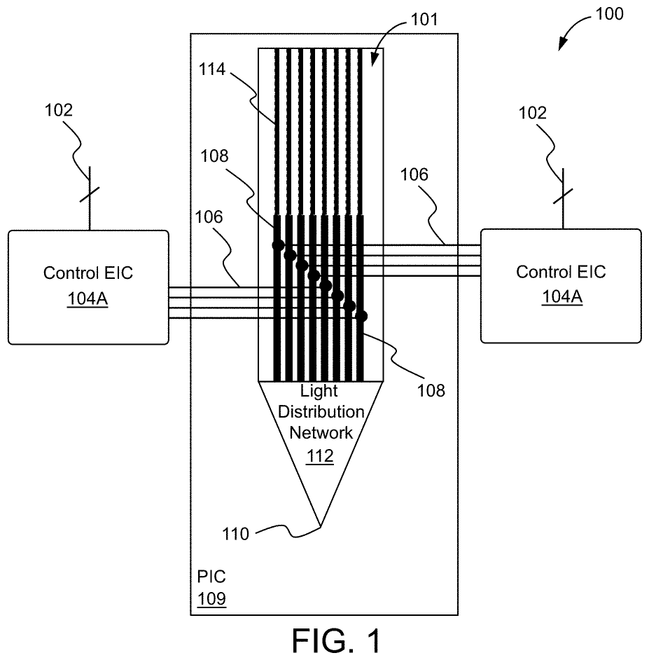

An optical phased array system with a relatively large number of phase shifter elements (e.g., thousands) can benefit from an optimized controller, such as an array of electronic phase shifter drivers controlled by an integrated digital beamforming controller (e.g., as shown in the examples of FIGS. 1-3). The electronic phase shifter driver circuits can be realized as DACs co-designed and optimized to provide the appropriate voltages and/or currents to the phase shifter elements to allow specific phase control, up to and in excess of 2·π radians, in adjustable increments. An individual DAC accepts digital electronic inputs to direct a specific phase setting for the corresponding phase shifter element. In an array of thousands of such DACs, the amount of digital data required to direct the electronic inputs to the thousands of DACs can be large, creating design tradeoffs of power, timing, bandwidth, crosstalk/interference, wiring congestion, and area footprint. An on-chip digital beamforming controller can reduce the system input data by logically performing computations that can be based on a phased array computational model to locally compute DAC input codes.

FIG. 1 shows an example single OPA system 100 with an OPA 101 located on a PIC 109 and controlled by two control EICs 104A, though in general one or many control EICs 104A could control a single OPA. Each interface bus 102 is electrically connected to a respective control EIC 104A. A set of DAC outputs 106 are electrically connected to a set of phase shifters 108. Input light 110 is optically coupled to a light distribution network 112, which optically couples the input light 110 to the set of phase shifters 108. The set of phase shifters 108 is optically coupled to a set of emitters 114, which can emit light. The input light 110 can be provided from a coherent optical source (e.g., a laser) that is coupled to (or integrated within) the PIC 109, which provides an optical wave that has as narrow linewidth and has a peak wavelength that falls in a particular range (e.g., between about 100 nm to about 1 mm, or some subrange thereof), also referred to herein as simply “light.” As used herein, the term emitter refers to an element that is able to both emit an optical wave and receive an optical wave, and may also be referred to as an optical antenna. In some implementations, the steering that is described herein may refer to steering an angle from which light will be received instead of an angle at which a beam will be transmitted.

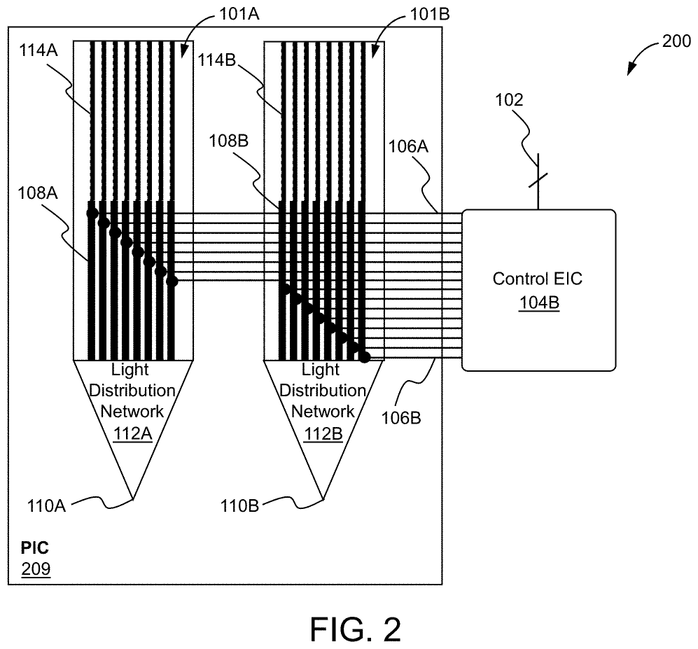

FIG. 2 shows an example two OPA system 200, comprising a first OPA 101A and a second OPA 101B each located on a PIC 209 and controlled by a control EIC 104B, which is electrically connected to an interface bus 102. The control EIC 104B has a first set of DAC outputs 106A electrically connected to a first set of phase shifters 108A, and a second set of DAC outputs 106B electrically connected to the second set of phase shifters 108B. A first input light 110A is optically coupled to a first light distribution network 112A, which optically couples the first input light 110A to the first set of phase shifters 108A. The first set of phase shifters 108A is optically coupled to a first set of emitters 114A, which can emit light. A second input light 110B is optically coupled to a second light distribution network 112B, which optically couples the second input light 110B to the second set of phase shifters 108B. The second set of phase shifters 108B is optically coupled to a second set of emitters 114B, which can emit light.

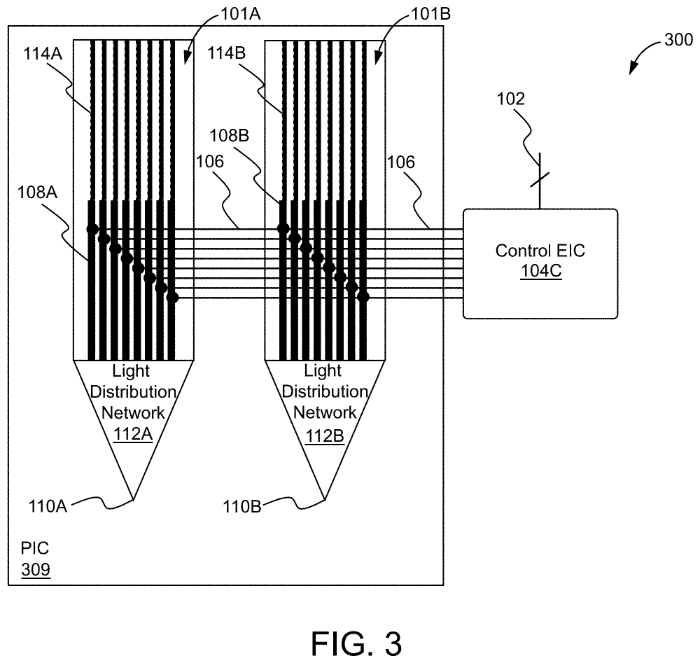

FIG. 3 shows an example two OPA system 300 with two OPAs located on a PIC 309 and controlled by a control EIC 104C, which is electrically connected to an interface bus 102. One or more of the DAC outputs can be used to control multiple respective phase shifters if the beamforming control implemented by the DAC outputs applied to one OPA can also be used for the other OPA. In this example, each of the DAC outputs 106 is sent to both a phase shifter in a first set of phase shifters 108A and a phase shifter in a second set of phase shifters 108B.

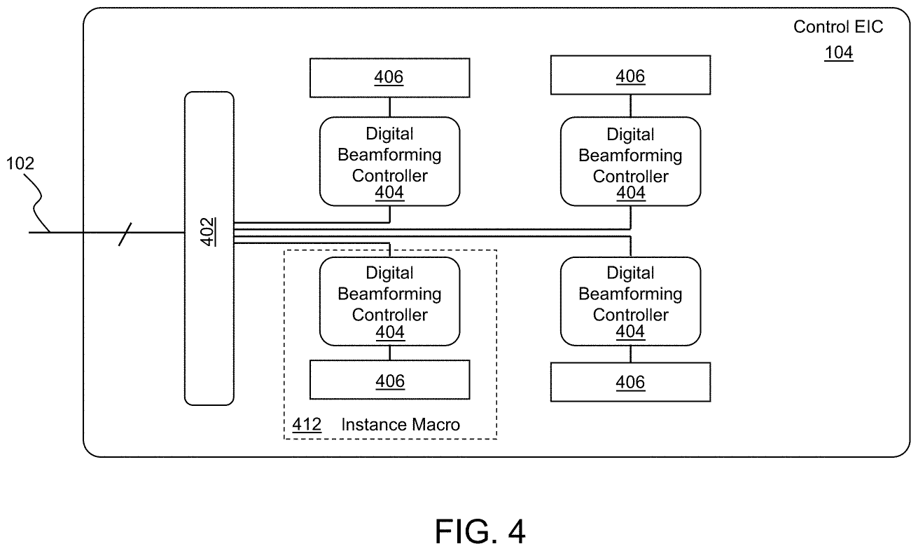

FIG. 4 shows an example interface bus 102 as input to a control EIC 104 that includes a set of final computational stage digital beamforming controllers 404 for computing codes used as input for DACs 406 that serve as phase shifter drivers. Thus, the control EIC 104 serves as an integrated digital beamforming controller, which can be configured to use data compression algorithms to simplify (or in some cases remove the need for) the interface bus 102 to the control EIC 104, thereby lowering communication power consumption and/or reducing communication time. The control EIC 104 can accept simple input commands on a dual-purpose interface bus and an upstream stage digital beamforming controller 402, such as a steering command directing one or more desired OPA tilt angles, focus distances, phase information, Zernike polynomial terms, calibration command(s) used for OPA factory tuning, or other term(s) that can be used to direct the emission of light from the OPA. The control EIC 104 could alternatively take no input whatsoever (e.g., removing a need for the interface bus 102) and run automatically based upon predetermined behavior.

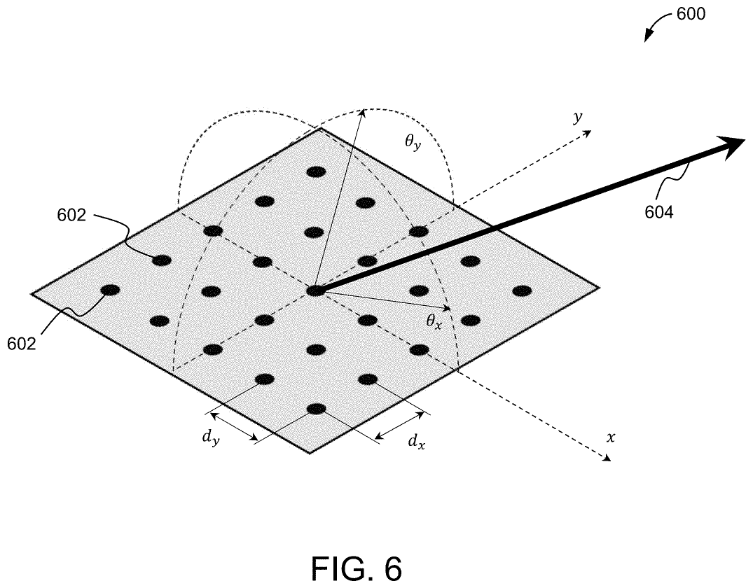

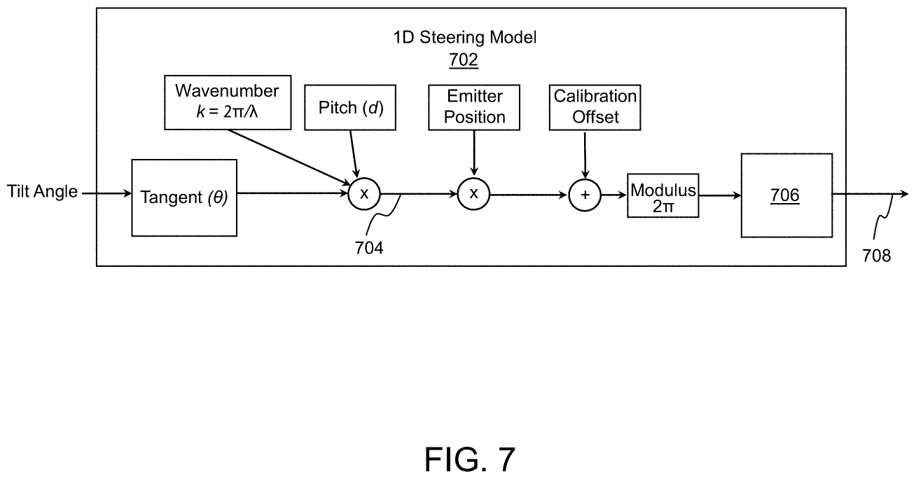

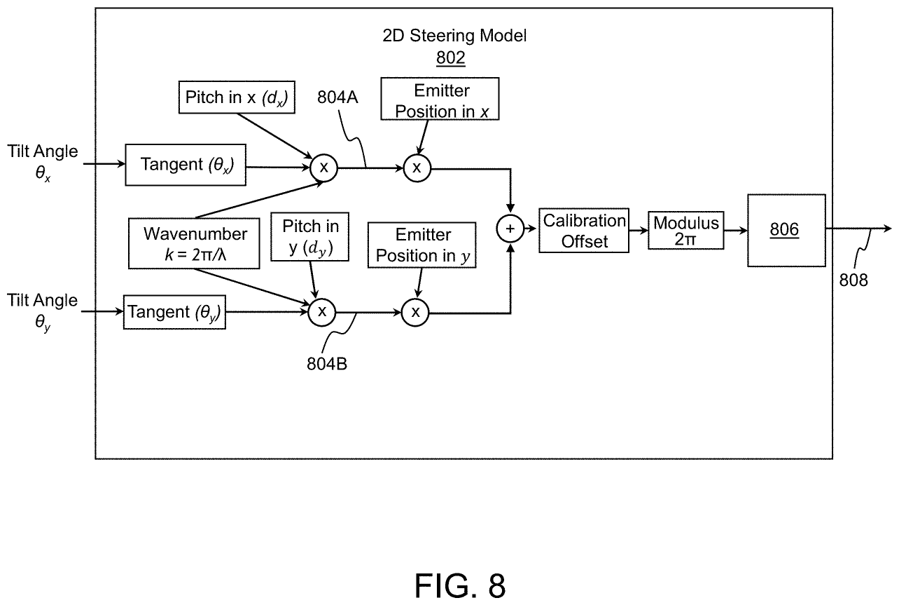

The control EIC 104 can compute the appropriate input codes for DACs 406 based upon the provided simple input command fed to a logically implemented computational phased array model. FIG. 7 shows an example of such a model for a single steering angle, defined in this example based on a “tilt angle” 0, though multiple simultaneous steering angles or multi-axis steering are also possible (e.g., FIG. 8 shows a model for an OPA with 2D electronic steering, for an OPA such as that in FIG. 6). An alternative control EIC 104 architecture could have a preprogrammed table of steering angles such that only a simple trigger signal (or alternatively, a predetermined number of input clock signals or a predefined time duration) is used as an indication of when to steer to the next angle. The logical computation blocks can be distributed across the chip (e.g., in different stages of digital beamforming controllers) so that the final logical computation for the appropriate input codes for DACs 406 occurs locally to those DACs 406. The control EIC 104 could also include a clock generator to avoid the need for an external clock input.

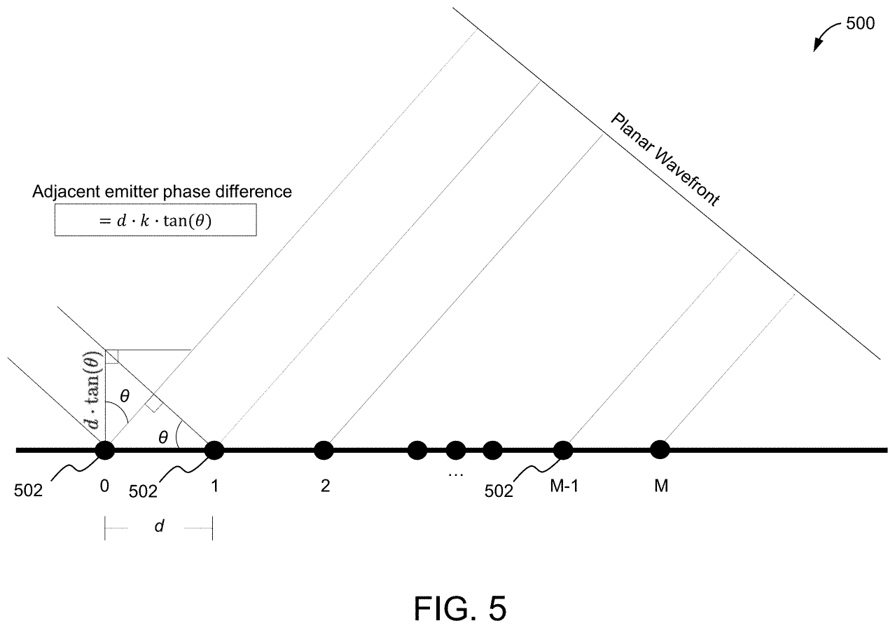

FIG. 5 shows a 1D array 500 of emitters 502 in an OPA. From an assumed tilt angle θ of a planar wavefront that is formed by constructive and destructive interference of coherent light waves emitted form the emitters 502, the relative phase difference between light waves being emitted from adjacent emitters 502 can be determined using the following expression.

d·k·tan(θ)

In this expression, d is the distance between the centers of adjacent emitters, and k is the wavenumber, which is equal to 2π/λ, where λ is the wavelength of the light waves. Alternatively, in other examples, a normalized wavenumber kₙₒᵣₘ could be used in place of the wavenumber k, where kₙₒᵣₘ=k/(2π), which would enable a phase shift to be provided (and stored) as a value in the range between 0 to 1 instead of the range between 0 to 2π. While a plane wave would correspond to an infinite number of emitters, in a practical implementation, there would be a finite number of emitters, such as the M emitters shown in FIG. 5, which would yield a particular array pattern with a main lobe of a beam propagating in the direction of the tilt angle θ.

FIG. 6 shows a 2D array 600 of emitters 602 emitting a beam with a main lobe propagating along a propagation axis 604. Along a first direction the separation between two adjacent emitters 602 is given by dₓ and along a second direction the separation between two adjacent emitters 602 is given by d_{y}. Other arrangement of emitters can include 1D arrays or 2D arrays of emitters that have any of a variety of emission characteristics. For example, in some OPAs, the emitters are not point emitters that emit light from a single location but rather linear emitters that emit light over the length of a grating, for example, or other extended emitter that emits light over the shape of the emission area. This will affect the emitted beam shape, but similar computations can be performed to determine a relative phase shift between emitter elements based on information about a desired beam tilt angle.

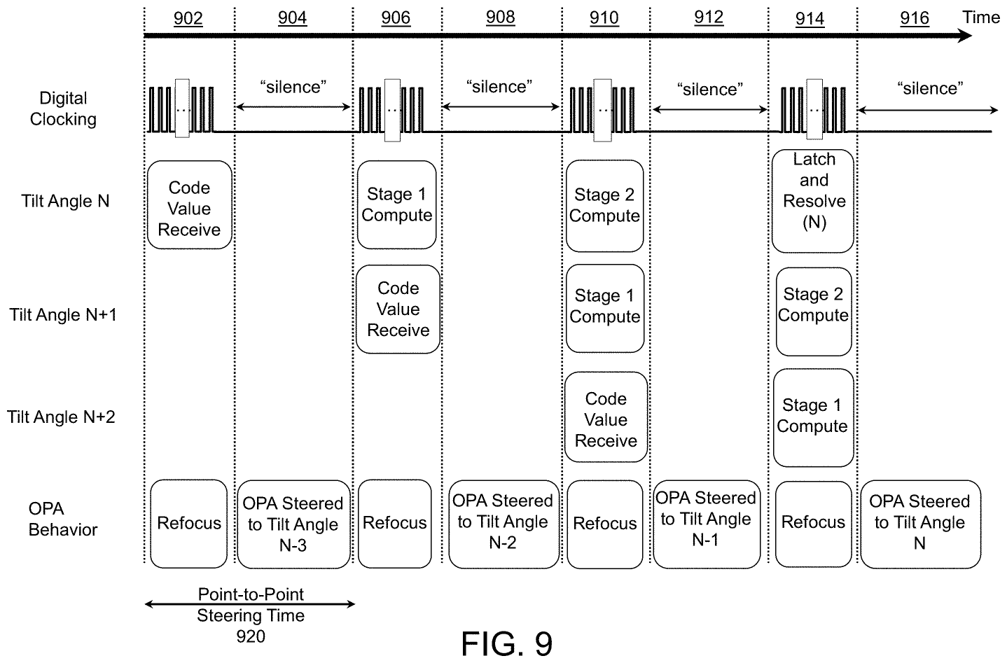

An advantage of reduced data communication into the EIC is the reduction of crosstalk and interference to other nearby sensitive circuitry such as the DAC circuits or receivers. In a compact LiDAR sensor, the EIC may be physically co-located or co-integrated with sensitive transimpedance amplifiers. In some implementations, digital clocking may be undesirable nearby such circuits due to the noise caused by such clock signals. By simplifying the interface to the EIC and performing DAC input code computation on-the-fly, the amount of digital switching needed for signals propagating over the interface bus is greatly reduced. FIG. 9 shows an example timing diagram where the digital beamformer controller is unclocked during a significant portion of the point-to-point steering time. Thus, the clock signal can be turned off at those times (e.g., during periodic silence time intervals), allowing for operation of the noise-sensitive components during those times, as described in more detail below.

A digital beamforming controller can accept several different types of inputs from the interface bus. An example system could receive on the interface bus a digital representation of the desired steering angle(s), and then calculate the required adjacent emitter phase difference(s) necessary for the specified tilt angle(s). Another example system could receive on the interface bus a digital representation of the adjacent emitter phase difference(s) to reduce the amount of computation necessary on the EIC. Another example system could have a memory table storing a list of possible steering angles or adjacent emitter phase differences, and advance to the next steering angle or phase difference based upon a trigger input on the interface bus. Another example system could calculate the next steering angle based upon a given representation of angular resolution from the interface bus or from stored memory integrated with or otherwise coupled to the control electronic IC. The memory can be implemented, for example, using flip-flops, a register file, static random access memory (SRAM), and/or dynamic random access memory (DRAM).

FIG. 7 shows an example 1D computational steering model 702 for execution by a digital beamforming controller, with respect to an emitter arrangement shown in FIG. 5. This instance of a computational model takes an OPA tilt angle θ as an input. The model calculates the tangent of the input tilt angle θ (via look-up-table or otherwise) and multiplies the result by the wavenumber and the emitter pitch (distance between adjacent emitter elements) to determine the adjacent emitter phase difference 704. An alternative version of the model could directly accept the adjacent emitter phase difference as an input. Another alternative version could implement multi-axis steering if the OPA supports it (such as with a 2D emitter array). For each emitter, the adjacent emitter phase difference is multiplied by the phase shifter position, and the resulting product is summed with the calibration offset for the emitter modulus 2·π radians. Finally, a phase to DAC input code conversion 706 results in the DAC input code 708 corresponding to the emitter being considered.

FIG. 8 shows an example 2D computational steering model 802 for execution by a digital beamforming controller, with respect to an emitter arrangement shown in FIG. 6. This instance of a computational model takes two OPA tilt angles as inputs. For each of the two input tilt angles, the model calculates a first adjacent emitter phase difference 804A and a second adjacent emitter phase difference 804B in a manner similar to the computation of the 1D computational steering model 702. An alternative version of the model could directly accept one or both of adjacent emitter phase differences as an input. Another alternative version could implement multi-axis steering if the OPA supports it (such as with a 2D emitter array). For each emitter, the adjacent emitter phase difference is multiplied by the phase shifter position (e.g., emitter position in x, emitter position in y), and the resulting products are summed together and with the calibration offset for the emitter modulus 2·π radians. Finally, a phase to DAC input code conversion 806 results in the DAC input code 808 corresponding to the emitter being considered.

The computational phased array model can be broken into multiple pipelined computation stages to reduce the computation duration. Pipelined digital beamforming controllers can provide system improvements such as lowering area, power consumption, crosstalk/interference, and/or packaging complexity. An example segmentation into three pipelining computation stages is shown in FIG. 9. For a tilt angle N, a steering related code value is received in a reception stage (labeled “Code Value Receive”) occurring during a time slot 902, and the adjacent phase shifter difference is calculated in a first compute stage (labeled “Stage 1 Compute”) occurring in a time slot 906. During a second compute stage (labeled “Stage 2 Compute”) occurring in a time slot 910, the computation considers the location of each emitter based upon a stored value in memory and calculates the phase contribution of each individual emitter, considering a calibration offset which is also stored in memory. In this example, the second compute stage computation performs a modulus operation to ensure that the phase value is within the capability of the phase shifter device (e.g., zero to 2·π). The final pipelining stage (labeled “Latch and Resolve (N)”) occurring in a time slot 914 latches the computed value to the DACs for resolution over a resolving time period (e.g., about 1 millisecond) to steer a beam from the OPA to a particular title angle (e.g., tilt angle N). The OPA will then be steered to the tilt angle N during a time slot 916 in which OPA behavior can occur for that tilt angle N, as described in more detail below. A corresponding series of pipelining stages occur, in different respective time slots as shown in FIG. 9, for each of the other tilt angles being computed (tilt angle N+1, and tilt angle N+2) during the time period illustrated. There are also corresponding pipelining stages that occur for other tilt angles (tilt angle N−1, tilt angle N−2, and tilt angle N−3, not shown in FIG. 9), such that the OPA is steered to the appropriate tilt angle by the time slot before the time slot in which the OPA behavior occurs for that tilt angle.

The increased latency created by pipelined computation would not matter in many applications, such as a LiDAR sensor steering in a predetermined raster beam pattern. By implementing digital pipelining, the digital beamforming controller can have a high duty cycle between clocked digital switching (e.g., using a periodic square wave clock signal at a given clocking frequency, labeled as “Digital Clocking” at the top of FIG. 9) and unclocked digital “silence” time intervals in which there is no clock signal being distributed to circuitry of the digital beamforming controller, allowing the OPA behavior described at the bottom of FIG. 9. In some implementations, the digital silence time intervals dominate the duty cycle between the clocked time intervals that are interleaved with the digital silence time intervals (e.g., digital silence time intervals can be greater than the clocked time intervals by a factor of 2, 5, 10, or greater). Such a system has advantages for LiDAR to allow the sensitive optical receive circuitry an increased amount of time to capture and process the received optical signal while the OPA is steered to a given tilt angle, as shown in the time slots 904, 908, 912, and 916 in FIG. 9. For example, part of the OPA behavior that occurs during each digital silence time interval includes time for a modulated optical wave to be transmitted to a target at a given steering angle, reflect back from the target, and detected in an optical receiver. Alternatively, in a communications system, each digital silence period can be used for sending and receiving information to and from a remote communication node at a given steering angle. By pipelining the digital computation, all noisy clocking can be performed concurrently with the refocusing duration of the OPA, leaving a relatively large time interval for the OPA behavior that occurs for a given tilt angle.

Some OPA systems are configured to perform calibration procedures to correct for fabrication errors. In some examples, a digital beamforming controller can include a calibration mode to provide functional and speed improvements to OPA calibration. For example, improvements to the speed of calibration can be achieved by including on-board logic that automatically sequences through the calibration sequence. This calibration sequence may be internally timed, synchronized to an external trigger input, or generated by an external trigger output.

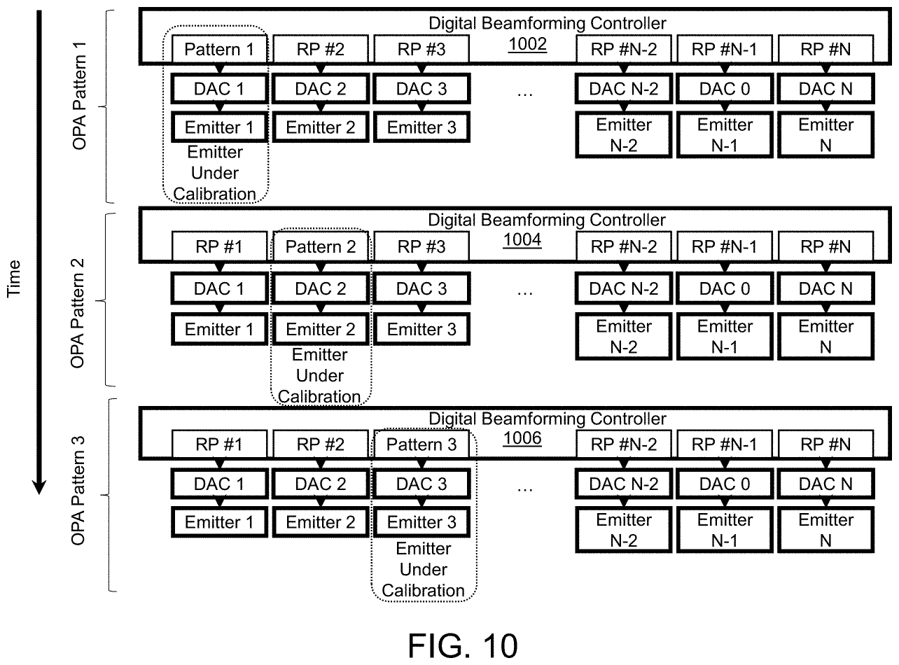

FIG. 10 shows an example optical phased array performing a calibration procedure. In a first time window configured to calibrate OPA Pattern 1 for Emitter 1, a digital beamforming controller 1002 generates respective digital signals that either correspond to a known pattern (e.g., Pattern 1) or a pseudo-random pattern (e.g., RP #2, . . . , RP #N). Each digital signal is transformed into an analog signal by respective DACs (e.g., DAC 1, . . . , DAC N) that is then sent as input to a respective emitter (e.g., Emitter 1, . . . , Emitter N). In a second time window configured to calibrate OPA Pattern 2 for Emitter 2, a digital beamforming controller 1004 generates respective digital signals that either correspond to a known pattern (e.g., Pattern 2) or a pseudo-random pattern (e.g., RP #1, RP #3, . . . , RP #N). Each digital signal is transformed into an analog signal by respective DACs (e.g., DAC 1, . . . , DAC N) that is then sent as input to a respective emitter (e.g., Emitter 1, . . . , Emitter N). In a third time window configured to calibrate OPA Pattern 3 for Emitter 3, a digital beamforming controller 1006 generates respective digital signals that either correspond to a known pattern (e.g., Pattern 3) or a pseudo-random pattern (e.g., RP #1, RP #2, RP #4, . . . , RP #N). Each digital signal is transformed into an analog signal by respective DACs (e.g., DAC 1, . . . , DAC N) that is then sent as input to a respective emitter (e.g., Emitter 1, . . . , Emitter N). In some examples, the digital beamforming controllers 1002, 1004, and 1006 are all the same digital beamforming controller, configured to calibrate different emitters. Although FIG. 10 shows one emitter undergoing calibration per a time window, other implementations can have more than one emitter undergoing calibration per a time window (e.g., a first known pattern associated with a first emitter and a second known pattern associated with a second emitter, with all other emitters receiving pseudo-random pattern as inputs).

Referring to FIG. 10, the calibration procedure comprises logical operations implementing a pseudo-random-bit-sequence generator which can be used to provide random input signals to all DACs except for one or more DACs which are connected to a separate, known calibration sequence, such as a linear ramp in control signal or phase. A pseudo-random pattern (RP) is fed to the DAC inputs aside from an emitter under calibration. Such an implementation intentionally “spoils” the majority of the OPA beam, reducing the effect of one or more emitters so as to aid in the calibration of one or more emitters undergoing calibration. In other examples, instead of a pseudo-random pattern, a non-random background signal (such as a constant value) is used for all DAC inputs except for one or more DACs which are connected to a known calibration sequence corresponding to one or more emitters undergoing calibration.

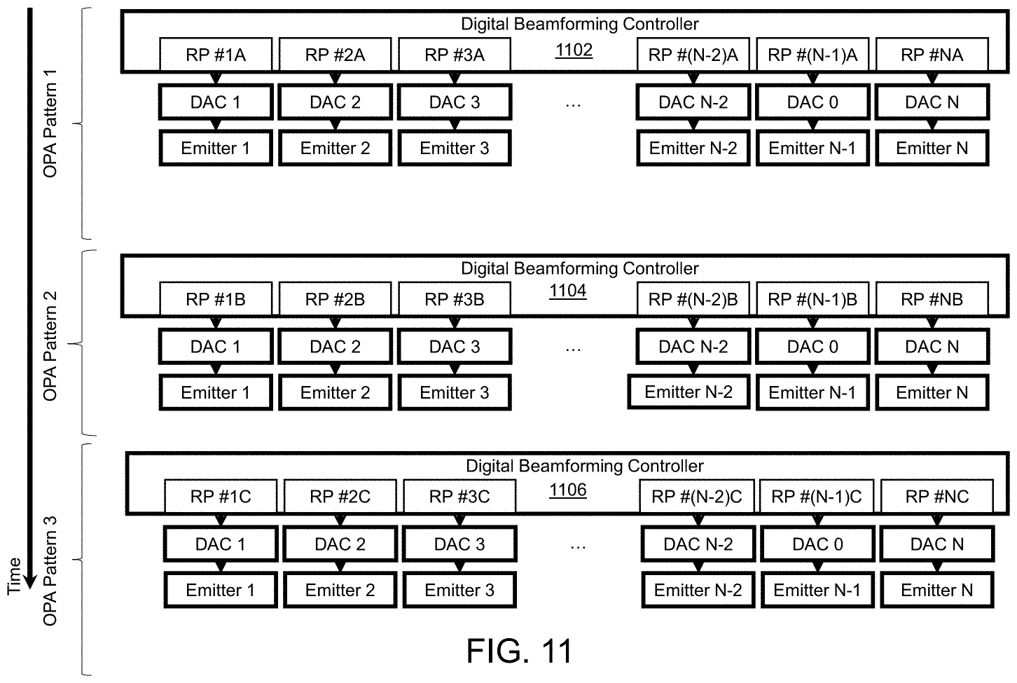

FIG. 11 shows an example optical phased array performing a calibration procedure where the beam formed by the OPA is repeatedly “spoiled” by a different pseudo-random pattern. Such a calibration procedure may be used for constant-false-alarm-rate calibration of a LiDAR OPA. In a first time window configured to calibrate a pseudo-random OPA Pattern 1, a digital beamforming controller 1102 generates respective digital signals that correspond to a pseudo-random pattern (e.g., RP #1, . . . , RP #N). Each digital signal is transformed into an analog signal by respective DACs (e.g., DAC 1, . . . , DAC N) that is then sent as input to a respective emitter (e.g., Emitter 1, . . . , Emitter N). In a second time window configured to calibrate pseudo-random OPA Pattern 2, a digital beamforming controller 1104 generates respective digital signals that correspond to a pseudo-random pattern (e.g., RP #1, . . . , RP #N). Each digital signal is transformed into an analog signal by respective DACs (e.g., DAC 1, . . . , DAC N) that is then sent as input to a respective emitter (e.g., Emitter 1, . . . , Emitter N). In a third time window configured to calibrate pseudo-random OPA Pattern 3, a digital beamforming controller 1106 generates respective digital signals that correspond to a pseudo-random pattern (e.g., RP #1, . . . , RP #N). Each digital signal is transformed into an analog signal by respective DACs (e.g., DAC 1, . . . , DAC N) that is then sent as input to a respective emitter (e.g., Emitter 1, . . . , Emitter N). In some examples, the digital beamforming controllers 1102, 1104, and 1106 are all the same digital beamforming controller.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an array of emitter elements;
an array of phase shifter elements, each phase shifter element configured to apply an optical phase shift to an optical wave that propagates through the phase shifter element and propagates to a corresponding emitter element, where the optical phase shift is based on an electrical signal provided to the phase shifter element;
an array of driver elements, each driver element configured to provide an electrical signal to at least one of the phase shifter elements based on a digital code value received at an input of the driver element; and
digital control circuitry configured to compute one or more digital code values that are provided to respective inputs of driver elements in the array of driver elements based on processing optical phased array control information, the processing including:
computing optical phase shift information based at least in part on the optical phased array control information, and
computing a corresponding digital code value based at least in part on the optical phase shift information.

2. The apparatus of claim 1, wherein optical phased array control information comprises steering information associated with steering at least one optical beam formed by optical interference among optical waves emitted from the emitter elements in the array of emitter elements.

3. The apparatus of claim 2, wherein the steering information is based on a tilt angle of a propagation axis that is perpendicular to a wavefront of the optical beam with respect to a reference axis that is defined relative to a plane over which the array of emitter elements are distributed.

4. The apparatus of claim 3, wherein the steering information is computed by the digital control circuitry based on the tilt angle, a wavelength of the optical waves, and a distance between adjacent emitter elements in the array of emitter elements.

5. The apparatus of claim 2, wherein optical phase shift information associated with a particular emitter element is computed based at least in part on the steering information and a position of the particular emitter element in the array of emitter elements.

6. The apparatus of claim 5, wherein a digital code value computed based at least in part on the optical phase shift information associated with the particular emitter element is computed based at least in part on calibration information associated with the particular emitter element.

7. The apparatus of claim 2, wherein the digital control circuitry is clocked by a clock signal during a sequence of clocked time intervals that are interleaved with a sequence of digital silence time intervals in which no clock signal is being distributed to the digital control circuitry.

8. The apparatus of claim 7, wherein during each of the clocked time intervals the digital control circuitry is computing at least a portion of the optical phase shift information, and during each of the digital silence time intervals the optical beam is steered to a predetermined point or within a predetermined plane.

9. The apparatus of claim 8, wherein the optical phase shift information and the corresponding digital code value are computed in a plurality of pipelined computing stages that occur within respective clocked time intervals and that include a final computing stage in which the corresponding digital code value is provided to a driver element over a resolving time interval.

10. The apparatus of claim 1, wherein optical phased array control information comprises calibration information associated with calibrating at least one individual emitter element in the array of emitter elements.

11. The apparatus of claim 10, wherein digital code values for a plurality of emitter elements other than the individual emitter element being calibrated are computed based on a pseudo-random pattern.

12. A method for operating an optical phased array comprising an array of emitter elements, the method comprising:
applying, by each phase shifter element in an array of phase shifter elements, an optical phase shift to an optical wave that propagates through the phase shifter element and propagates to a corresponding emitter element, where the optical phase shift is based on an electrical signal provided to the phase shifter element;
providing, by each driver element in an array of driver elements, an electrical signal to at least one of the phase shifter elements based on a digital code value received at an input of the driver element; and
computing, by digital control circuitry, one or more digital code values that are provided to respective inputs of driver elements in the array of driver elements based on processing optical phased array control information, the processing including:
computing optical phase shift information based at least in part on the optical phased array control information, and
computing a corresponding digital code value based at least in part on the optical phase shift information.

13. An apparatus comprising:
an array of emitter elements;
an array of phase shifter elements, each phase shifter element configured to apply an optical phase shift to an optical wave that propagates through the phase shifter element and propagates to a corresponding emitter element, where the optical phase shift is based on an electrical signal provided to the phase shifter element;
an array of driver elements, each driver element configured to provide an electrical signal to at least one of the phase shifter elements based on a digital code value received at an input of the driver element; and
digital control circuitry configured to compute one or more digital code values that are provided to respective inputs of driver elements in the array of driver elements, wherein the digital control circuitry is clocked by a clock signal during a sequence of clocked time intervals;
wherein the computing by the digital control circuitry includes:
during a first of the clocked time intervals the digital control circuitry is computing at least a portion of a first digital code value provided to an input of a first driver element,
during a second of the clocked time intervals, after the first of the clocked time intervals, the digital control circuitry is computing at least a portion of a second digital code value provided to the input of the first driver element, and
during an intermediate time interval, between the first of the clocked time intervals and the second of the clocked time intervals, an optical beam formed by optical interference among optical waves emitted from the emitter elements in the array of emitter elements is steered to a predetermined point or within a predetermined plane.

14. The apparatus of claim 13, wherein the optical beam is steered to a predetermined point or within a predetermined plane based at least in part on the first digital code value.

15. The apparatus of claim 13, wherein the one or more digital code values are computed based on processing optical phased array control information received by the digital control circuitry.

16. The apparatus of claim 15, wherein the optical phased array control information comprises steering information associated with steering at least one optical beam formed by optical interference among optical waves emitted from the emitter elements in the array of emitter elements.

17. The apparatus of claim 16, wherein the steering information is based on a tilt angle of a propagation axis that is perpendicular to a wavefront of the optical beam with respect to a reference axis that is defined relative to a plane over which the array of emitter elements are distributed.

18. The apparatus of claim 17, wherein the steering information is computed by the digital control circuitry based on the tilt angle, a wavelength of the optical waves, and a distance between adjacent emitter elements in the array of emitter elements.

19. The apparatus of claim 16, wherein optical phase shift information associated with a particular emitter element is computed based at least in part on the steering information and a position of the particular emitter element in the array of emitter elements.

20. The apparatus of claim 13, wherein the intermediate time interval comprises a digital silence time interval in a sequence of digital silence time intervals interleaved with the clocked time intervals, where, in each digital silence time interval, no clock signal is being distributed to the digital control circuitry.

21. A method for operating an optical phased array comprising an array of emitter elements, the method comprising:
applying, by each phase shifter element in an array of phase shifter elements, an optical phase shift to an optical wave that propagates through the phase shifter element and propagates to a corresponding emitter element, where the optical phase shift is based on an electrical signal provided to the phase shifter element;
providing, by each driver element in an array of driver elements, an electrical signal to at least one of the phase shifter elements based on a digital code value received at an input of the driver element; and
computing, by digital control circuitry, one or more digital code values that are provided to respective inputs of driver elements in the array of driver elements, wherein the digital control circuitry is clocked by a clock signal during a sequence of clocked time intervals;
wherein the computing by the digital control circuitry includes:
during a first of the clocked time intervals the digital control circuitry is computing at least a portion of a first digital code value provided to an input of a first driver element,
during a second of the clocked time intervals, after the first of the clocked time intervals, the digital control circuitry is computing at least a portion of a second digital code value provided to the input of the first driver element, and
during an intermediate time interval, between the first of the clocked time intervals and the second of the clocked time intervals, an optical beam formed by optical interference among optical waves emitted from the emitter elements in the array of emitter elements is steered to a predetermined point or within a predetermined plane.
